(19) United States
(12) Patent Application Publication
(10) Pub. No.: US 2025/0390885 A1
(43) Pub. Date: Dec. 25, 2025

(54) DATA BASE QUERYING OF STORED DATA STRUCTURES FOR OPTIMIZED DATA MANAGEMENT, DATA RESOURCE UTILIZATION AND TRANSFER

(71) Applicants: Barath Jayaraman, Fort Mill, SC (US); Brijesh Vaman, Stallings, NC (US)

(72) Inventors: Barath Jayaraman, Fort Mill, SC (US); Brijesh Vaman, Stallings, NC (US)

(21) Appl. No.: 18/751,898

(22) Filed: Jun. 24, 2024

(51) Int. Cl. G06Q 20/40; G06Q 20/34; G06Q 20/36

(52) U.S. Cl. CPC G06Q 20/405; G06Q 20/351; G06Q 20/36

(57) ABSTRACT

Systems and methods determine that an optimization operation for data base querying is being initiated and receive item data associated with item(s) obtainable by transferring resource(s) to an external location. Database(s) storing stored object data related to a plurality of virtual objects are queried, and the resource(s) are associated with one of the plurality of virtual objects. The systems and methods also ascertain, from the stored object data and the item data, and select which of the plurality of virtual objects optimizes improvements, where the ascertaining and selecting are included as part of the optimization operation. A selected virtual object from the plurality of virtual objects is applied to an exchange operation to transfer the resource(s) to the external location.

### FIELD OF THE INVENTION

This invention relates generally to the field of data base querying, and more particularly embodiments of the invention relate to systems and methods for querying data structures for optimized data management, data resource utilization, and transfer.

### BACKGROUND OF THE INVENTION

Numerous inefficiencies, including required manual intervention, exist that limit optimization of data management and virtual object utilization. Often systems have several virtual objects that may be selected for different tasks, and each virtual object provides different types of improvements. Thus, a need exists for improve data analysis systems for virtual object optimization.

### BRIEF SUMMARY

Shortcomings of the prior art are overcome and additional advantages are provided through the provision of a computing system data base querying of stored object data structures for optimized data management. The computing system includes at least one processor, a communication interface communicatively coupled to the at least one processor, and a memory device storing executable code. When executed, the executable code causes the at least one processor to, at least in part, determine that an optimization operation for data base querying is being initiated. Item data associated with at least one item is received, where the at least one item is obtainable by transferring one or more resources to an external location. One or more databases storing stored object data related to a plurality of virtual objects is queried, and the one or more resources are associated with one of the plurality of virtual objects. The system ascertains, from the stored object data and the item data, and selects which of the plurality of virtual objects optimizes improvements, the ascertaining and selecting being included as part of the optimization operation. A selected virtual object from the plurality of virtual objects is then to an exchange operation to transfer the one or more resources to the external location.

Also disclosed herein is a computer-implemented method that includes determining that an optimization operation for data base querying is being initiated, and receiving item data associated with at least one item, the at least one item being obtainable by transferring one or more resources to an external location. Further, the method includes querying one or more databases storing stored object data related to a plurality of virtual objects, the one or more resources being associated with one of the plurality of virtual objects, and ascertaining, from the stored object data and the item data, and selecting which of the plurality of virtual objects optimizes improvements, the ascertaining and selecting being included as part of the optimization operation. The method also includes applying a selected virtual object from the plurality of virtual objects to an exchange operation to transfer the one or more resources to the external location.

Further, a computing system is disclosed that includes at least one processor, a communication interface communicatively coupled to the at least one processor, and a memory device storing executable code. Execution of the executable code causes the processor to, at least in part, determine that an optimization operation for data base querying is being initiated, and receive item data associated with at least one item, the at least one item being obtainable by transferring one or more resources to an external location. The system also queries one or more databases storing stored object data related to a plurality of virtual objects, the one or more resources being associated with one of the plurality of virtual objects. Further, the system ascertains, from the stored object data and the item data, and selects which of the plurality of virtual objects optimizes improvements, the ascertaining and selecting being included as part of the optimization operation.

Various features disclosed herein as methods and systems may be achieved by combining in different embodiments, the details of which can be seen with reference to the following description and drawings.

### BRIEF DESCRIPTION

The claims at the conclusion of the specification particularly point out and distinctly claim features and advantages of the systems and methods disclosed herein. Various objects, features, and advantages are provided in the following description in conjunction with the accompanying drawings in which:

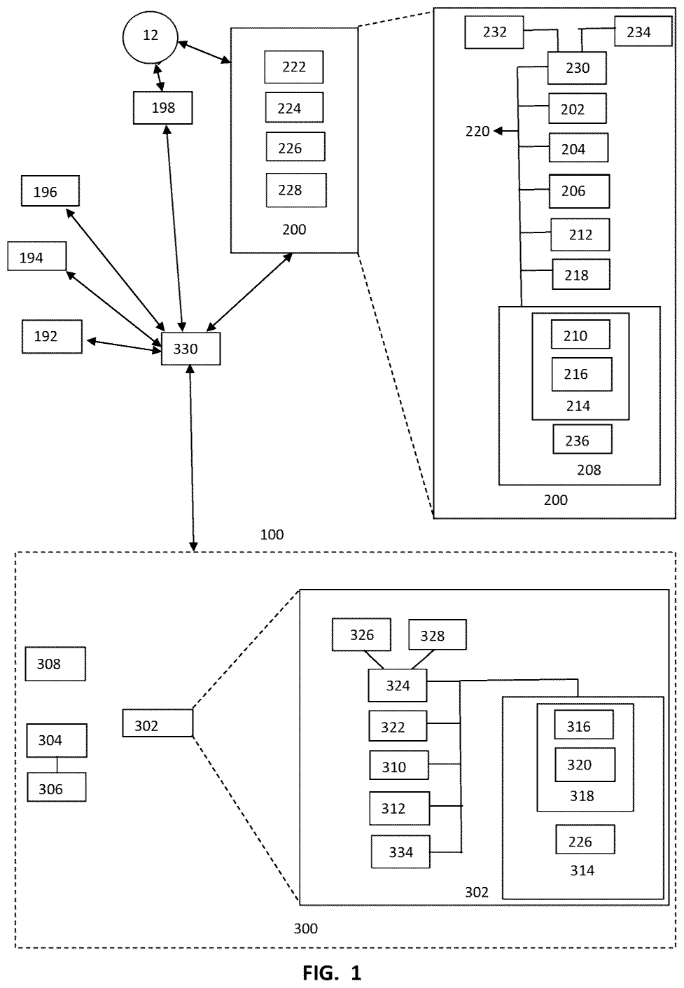

FIG. 1 illustrates a schematic representation of an enterprise system and its environment, in accordance with an embodiment of the present invention;

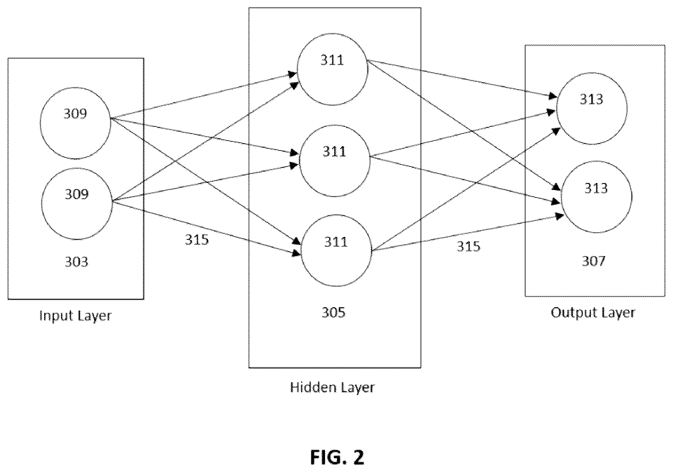

FIG. 2 is a diagram of a feedforward network, in accordance with an embodiment of the present invention;

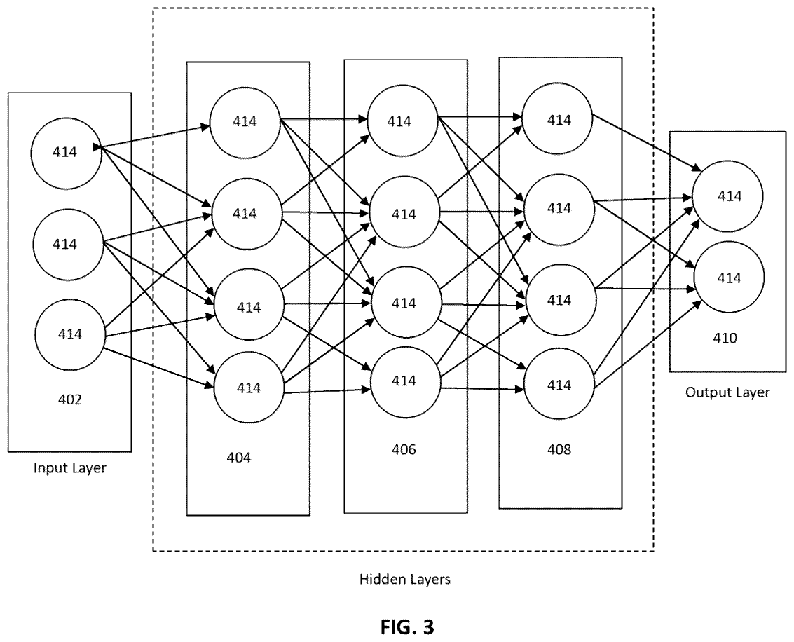

FIG. 3 depicts a visualization of a convolutional neural network (CNN), in accordance with an embodiment of the present invention;

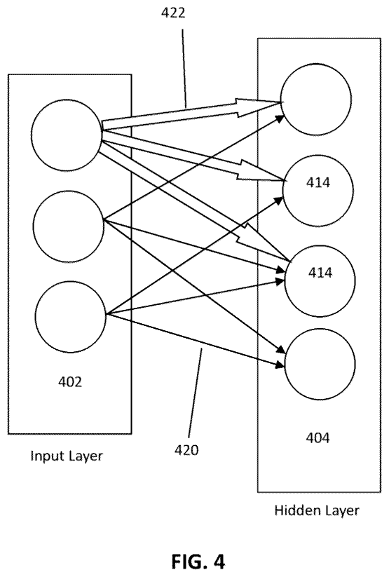

FIG. 4 depicts a detailed insight into a segment of the CNN illustrated in FIG. 3, in accordance with an embodiment of the present invention;

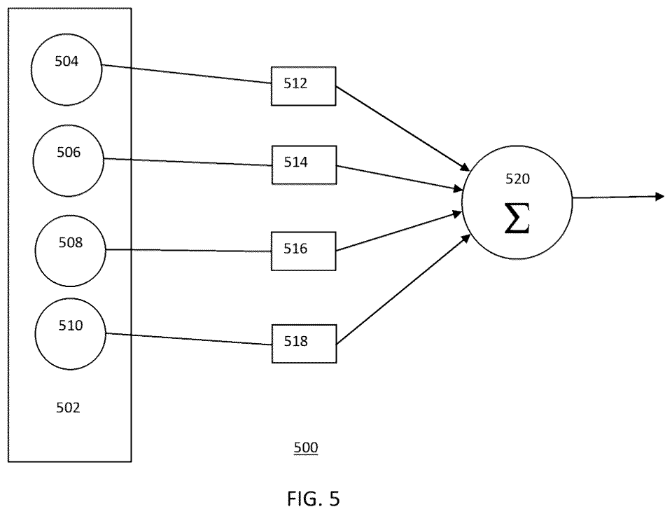

FIG. 5 depicts a diagrammatic representation of the weighted sum computation in a node of a CNN, in accordance with an embodiment of the present invention;

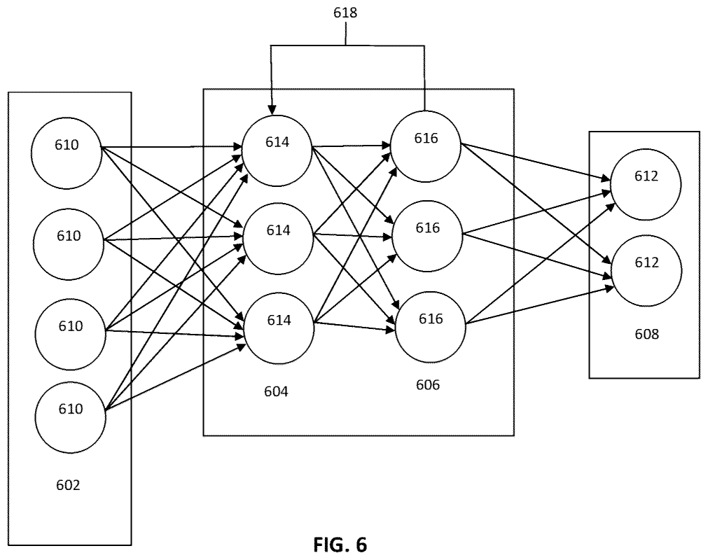

FIG. 6 depicts a recurrent neural network (RNN) utilized in machine learning, in accordance with an embodiment of the present invention;

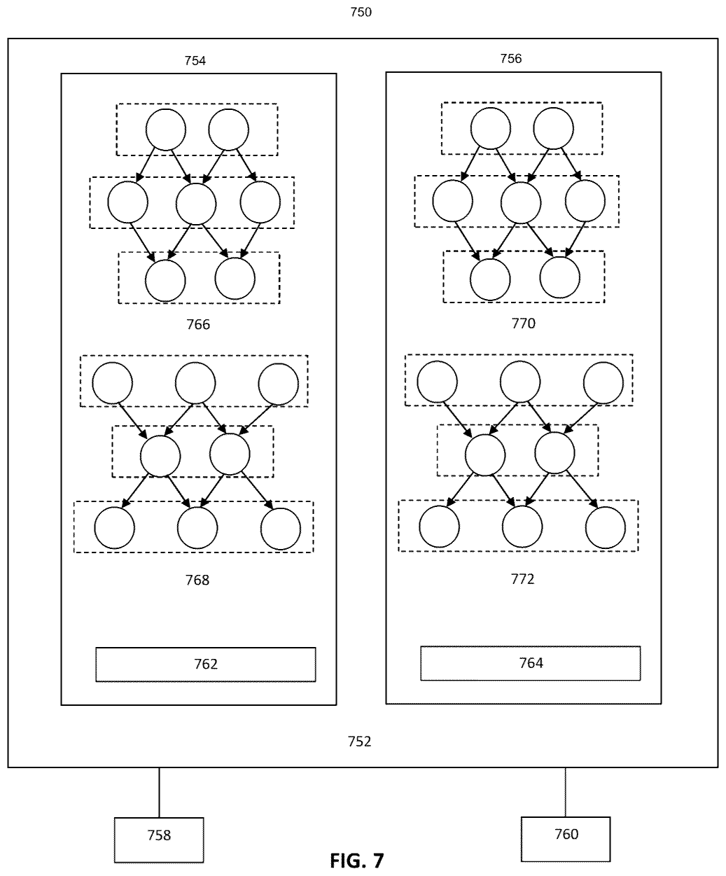

FIG. 7 depicts a schematic representation of artificial intelligence processing within an artificial intelligence program, in accordance with an embodiment of the present invention;

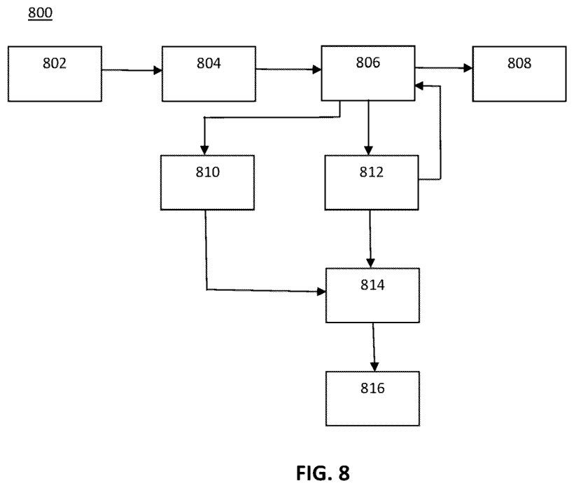

FIG. 8 depicts a flow chart depicting a method for training a machine learning model, in accordance with an embodiment of the present invention;

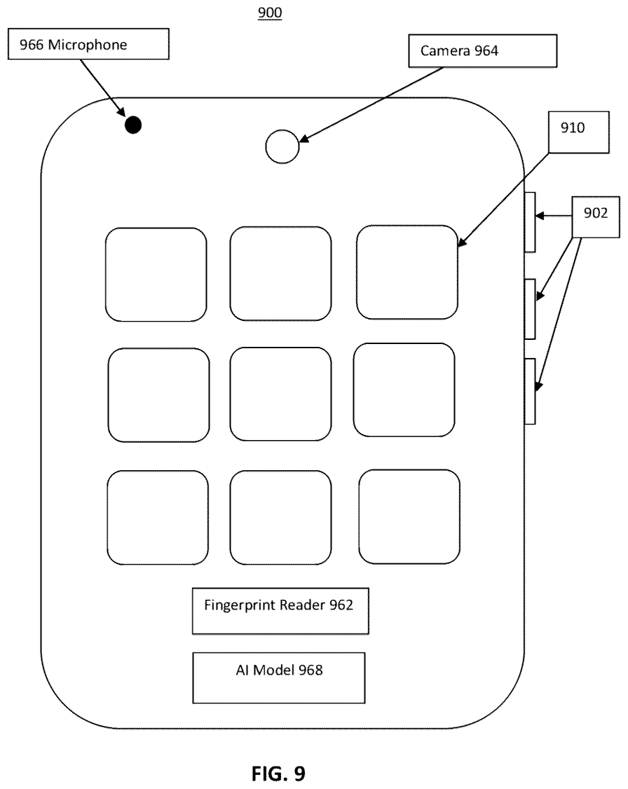

FIG. 9 depicts a front view of an example mobile device that includes a user interface, in accordance with an embodiment of the present invention;

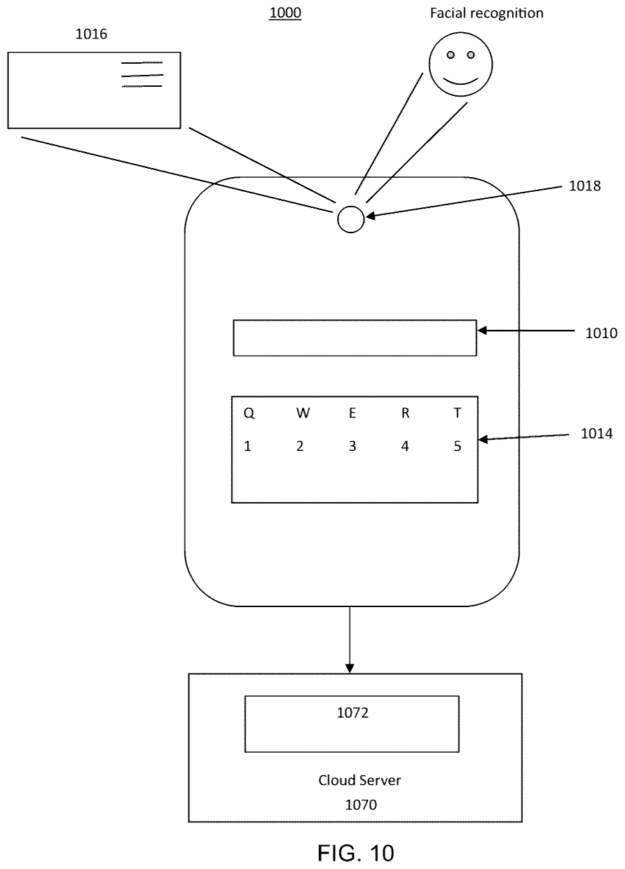

FIG. 10 depicts a front view of an example mobile device that includes a camera for scanning a card, in accordance with an embodiment of the present invention;

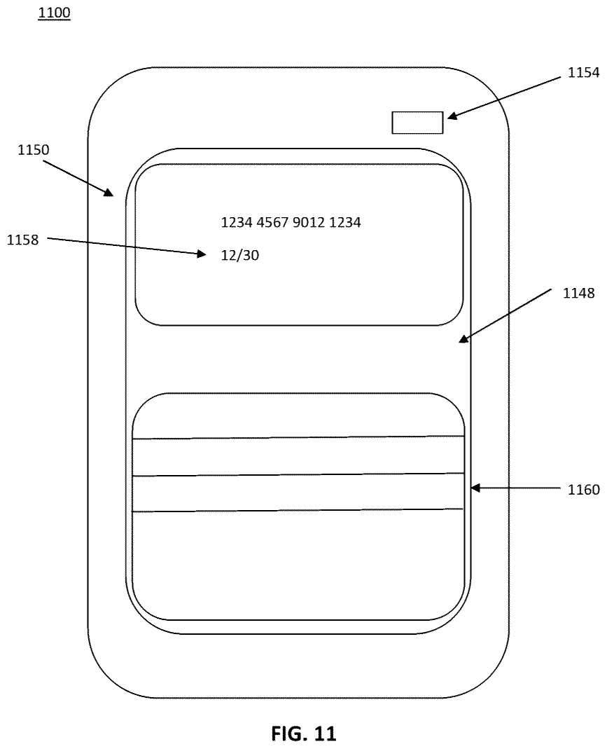

FIG. 11 depicts a front view of an example mobile device that includes a GUI with a digital wallet depicted on the Digital Wallet Purchase Screen, in accordance with an embodiment of the present invention;

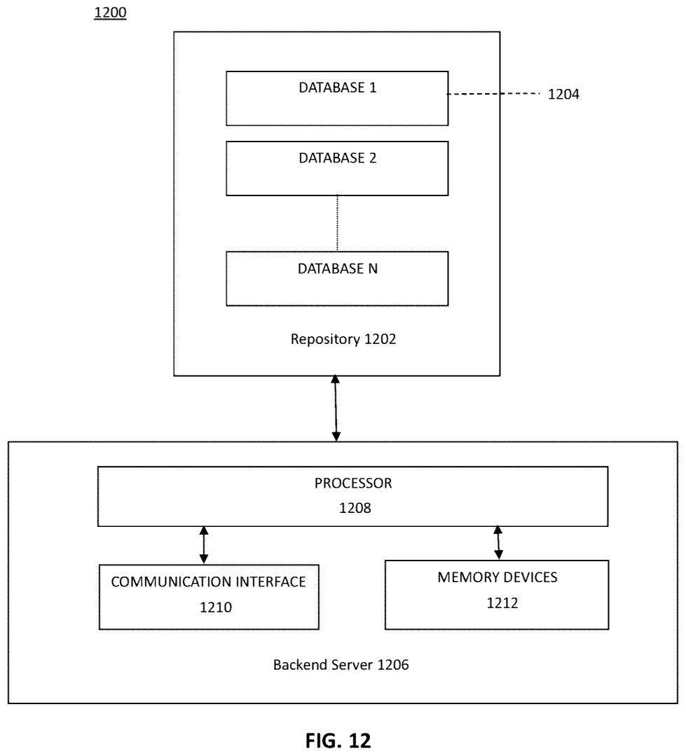

FIG. 12 is a block diagram of an example system-level architecture, in accordance with an embodiment of the present invention;

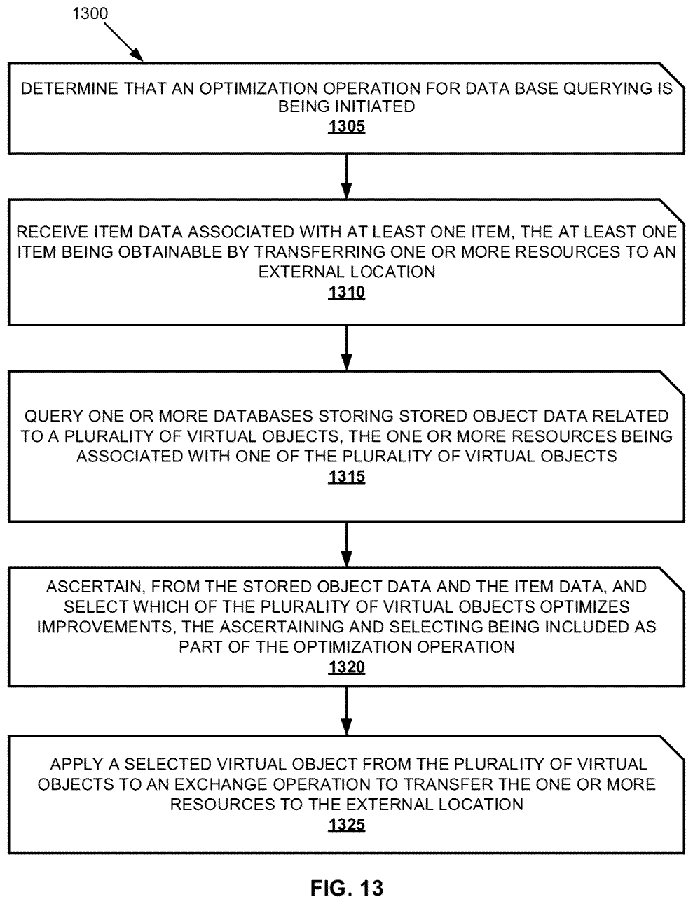

FIG. 13 depicts a block diagram of an example method, in accordance with an embodiment of the present invention; and

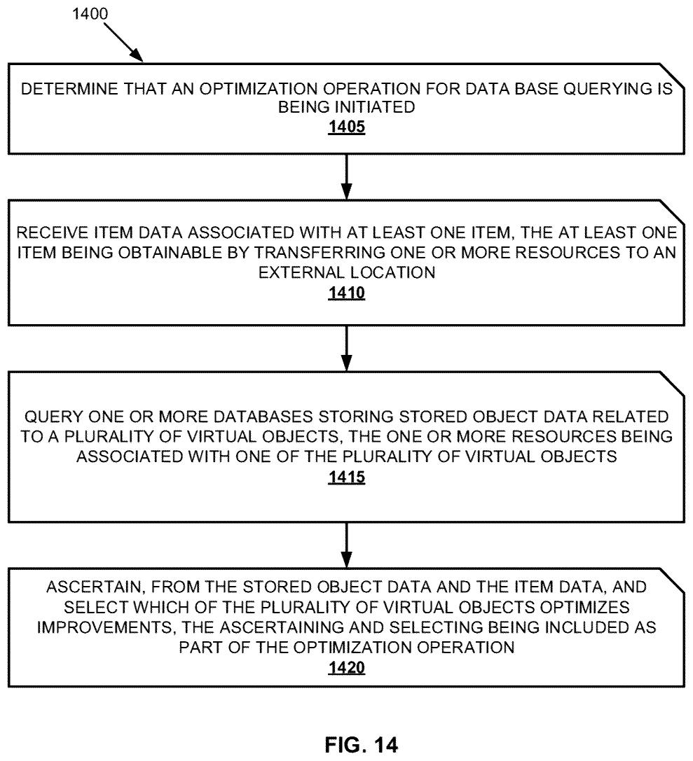

FIG. 14 depicts a block diagram of an example method, in accordance with an embodiment of the present invention.

### DETAILED DESCRIPTION

Certain features, advantages, and details of the present invention are explained more fully below with reference to the non-limiting examples illustrated in the accompanying drawings. The detailed description provides several non-limiting embodiments for illustration purposes only. The scope of the invention allows for substitutions, modifications, and/or additions as would be apparent to those skilled in the relevant art. For clarity, each disclosed aspect or feature is combinable with any other disclosed aspect or feature disclosed herein. Recurring elements are denoted consistently for clarity. Unless described or implied as exclusive alternatives, aspects described herein are cumulative such that features expressly associated with particular embodiments are combinable with other embodiments. Terminology and scientific notations deployed are congruent with conventional interpretations by professionals in the relevant domain, unless otherwise delineated.

Certain terminologies, such as “coupled,” “fixed,” “attached to,” “communicatively coupled to,” and “operatively coupled to,” warrant elucidation. They encapsulate both direct and intermediary connections, potentially involving secondary components. “Communicatively” and “operatively” couplings can signify affiliations that are either physical or electrical in nature.

The operational architecture of the disclosure relies heavily on computer-executable instructions corresponding to flowcharts and block diagrams, encapsulating methods and apparatuses. These instructions, designed for various processors in computers or comparable devices, instantiate the conceptualized mechanisms into functional entities.

These computer program instructions have the potential to be archived on computer-readable mediums. This facilitates the manifestation of specific operational behaviors in computational devices, bridging the gap between abstract diagrams and tangible, machine-operated processes.

The adaptability of these computational instructions is noteworthy. Whether autonomously executed or combined with human interventions, they exemplify the synergy between automated and manual actions, holistically bringing the disclosure to fruition.

The illustrative nature of the articulated embodiments is pivotal. While offering a structured approach, the disclosure remains amenable to myriad modifications and expansions. This flexibility ensures that its essence can be actualized in diverse modalities, all the while preserving its core principles.

Disclosed herein are systems and methods for optimizing payment method selection in digital wallets, specifically by automating the credit or debit card selection to use the credit or debit card that offers the most significant benefits for specific transactions. The system integrates a sophisticated algorithm that assesses a range of card benefits such as a resource distribution (e.g. cash back rewards), protection (e.g., insurance) coverage, extended security term (e.g., extended warranties), exchange protection (e.g., purchase protection), lower APRs, card limits, concierge services, and advanced fraud protection. Additionally, it incorporates contextual decision-making capabilities that consider the transaction type, merchant category, and historical user preferences to enhance the appropriateness of the selected card. This functionality is designed to operate seamlessly across both in-store and online purchases. This proactive approach ensures that cardholders maximize the utility and financial advantages of their cards, leading to increased user satisfaction and loyalty.

Digital wallets typically contain multiple payment cards, each offering different benefits such as cashback rewards, insurance coverage, extended warranties, and lower APRs. Users often face difficulties in selecting the most beneficial card for specific purchases. Most of the time, the same card is used for all transaction types as a default unless the customer manually chooses a different card based on the transaction type. This invention simplifies the choice by automating the selection process based on predefined criteria tailored to maximize user benefits for each transaction type, thus enhancing user convenience and financial efficiency

Credit and debit cards are commonly issued by traditional financial institutions, such as banks and credit unions, which may be categorized as retail, commercial, or investment banks based on the services they provide. Additionally, these cards can also be issued by non-financial entities such as technology companies (e.g., Apple, Robinhood), retail stores (e.g., Lowes, Macy's), and service providers in the travel and hospitality sector (e.g., airlines, hotels). Technology companies like Apple, PayPal, and Google provide digital wallet services that facilitate the storage and management of these cards digitally. Digital wallets allow users to perform transactions conveniently through various devices, including mobile phones, tablets, and computers, by storing card information securely and enabling quick access for online and in-store purchases. Additionally, digital wallets can be used to withdraw cash from ATMs, further enhancing their utility. Often, when non-financial institutions issue these cards, they do so in partnership with banks. However, evolving regulations and financial technologies may eventually enable these entities to issue cards independently, highlighting the importance of including such potential developments within the scope of the systems and methods described herein to maintain its relevance in future scenarios.

Most banks provide systems, software, and applications for online banking, facilitating tasks such as viewing account balances, bill paying, funds transfer, check deposit, and managing credit and debit cards. This includes requesting new cards, replacing existing ones, and opening new credit card and bank accounts—all without the need to visit or call the bank. Most banks also issue credit and debit cards tied to an online banking application. This enables cardholders to view transactions and make online payments. A debit card is directly linked to the cardholder's bank account, deducting funds immediately upon purchase. These cards can also be used to withdraw cash from ATMs. A credit card allows the cardholder to borrow funds from a pre-approved credit line for purchases, with the obligation to pay back the borrowed amount typically with interest, as set by the card issuer. Both types of cards often come with benefits such as cash back, airline miles, reward points, discounts at specific retailers, or travel perks. These benefits significantly influence consumer choice regarding which card to apply for or use regularly. However, many cardholders do not fully utilize these benefits, possibly due to forgetfulness, a lack of understanding, or difficulty accessing benefit details, which can often be obscured on issuers' websites or apps. Additionally, the card that is defaulted by the user in the digital wallet is often used for all types of transactions, unless manually changed, leading to suboptimal utilization of available benefits. The objective of this invention is to automate the selection of the most beneficial card for each transaction within a digital wallet, ensuring that users maximize their rewards and benefits with minimal effort. By displaying and automatically selecting the best card based on predefined criteria, this system significantly improves the overall cardholder experience.

Disclosed herein are systems that may be integrated within digital wallets that automatically selects the optimal payment card for transactions. This system can select the card based on system-defined criteria, user-defined criteria prioritizing specific categories, or a hybrid approach combining both. The selection may focus on comparing cashback-based benefits exclusively or include both cashback and non-cash benefits, such as travel perks and insurance coverage. An algorithm analyzes the benefits associated with each stored card and chooses the one offering the highest returns or benefits for the particular transaction, thereby enhancing user satisfaction and maximizing financial advantages.

The systems and methods disclosed herein introduce a novel approach for optimizing the selection of financial cards, such as credit and debit cards, within a digital wallet. The system involves an automated selection process based on predefined criteria, ensuring the cardholder uses the card with the most advantageous benefits for each transaction. This process may account for system-based criteria, user-defined criteria, or a hybrid of both. The benefits considered can include, but are not limited to, cashback, rewards points, discounts, or travel perks. The system dynamically compares these benefits, presenting the cardholder with the best option for maximizing their rewards. This innovative approach aims to improve the cardholder's experience by aiding them in understanding, remembering, and utilizing their card benefits to the fullest extent within a digital wallet environment.

### Overview of System and Environment (100)

FIG. 1 illustrates a schematic representation of an enterprise system (300) and its environment (100), in accordance with an embodiment of the present invention. This illustration showcases the complex connections and interactions between the mobile device (200) of a user (12), computer (198), and the overarching enterprise system (300), elucidating how a user (12) can derive benefits from the system's (300) services and products. The system (100) facilitates user (12) interactions with digital banking through both a computer (198) and a mobile device (200). This system ensures seamless operation and efficient data transactions across components. The mobile device (200) and the computer (198) are connected to the network (330), enabling data exchange with the enterprise system (300).

### Components of Mobile Device (200)

Central to the mobile device (200) is the processing unit (204). Examples of such processors in mobile devices include Qualcomm's Snapdragon series or Apple's A-series chipsets. The processing unit (204) handles the execution of instructions (210) and facilitates the operations of various applications and programs (214), including banking applications (216).

The memory device (206) in the mobile device (200) consists of volatile components such as RAM and non-volatile components like ROM. This memory device (206) temporarily stores data and instructions (210) required for the execution of applications (214).

The storage device (208) within the mobile device (200) incorporates long-term storage mediums such as solid-state drives and flash drives. This storage device (208) retains user data, application data, and other necessary information (236). Instructions (210) within the mobile device (200) are crucial sets of software codes that dictate its operations. These instructions (210) guide the processing unit (204) in executing tasks and running applications (214). The battery or power source (212), such as lithium-ion or lithium-polymer cells, powers the mobile device (200). This ensures uninterrupted operation of the device and its components.

Within the mobile device (200), various applications and programs (214) cater to diverse user needs. An example is the program (216), a banking application that allows users to perform financial transactions, manage accounts, and access card benefits.

The input-output system (218) in the mobile device (200) facilitates interactions via touchscreens, buttons, and other interfaces. This system (218) enables the user (12) to interact with applications (214) and execute commands.

Data flow in the mobile device (200) is managed by the intraconnect (220), such as a high-speed system bus. This intraconnect (220) ensures efficient communication between the processing unit (204), memory device (206), and storage device (208).

Visual output for the mobile device (200) is presented on the mobile display (222) using technologies such as OLED. The display (222) shows the user interface, application screens, and other visual data.

The mobile device (200)'s auditory functions are handled by a microphone (224) and a speaker (226). These components facilitate audio input and output for applications (214) requiring sound interaction.

For imaging and security functions, the mobile device (200) incorporates the camera (228). The camera (228) can be used for scanning QR codes, capturing images, and enabling video calls.

The communication interface (230) in the mobile device (200) connects to external networks. Data transmission is handled by the wireless communication device (232), such as Wi-Fi 6, and the wired communication device (234), for example, USB-C. This interface (230) ensures that the mobile device (200) can exchange data with the network (330) and other connected systems such as routers, modems, and other IoT devices.

The GPS (202) in the mobile device (200) provides location services, facilitating features such as location-based security and banking services. The GPS (202) helps in tracking the device's location and enhancing user experience through location-specific services.

Other data (236) such as cached data, pictures, and user preferences are stored within the mobile device (200), contributing to personalized user experiences and data richness. This data (236) is managed by the storage device (208) and is used by various applications (214).

### Components of Enterprise System (300)

The processing device (310) in the computing system (302) handles computational tasks using high-performance chipsets such as Intel Xeon or AMD EPYC processors. The processing device (310) executes instructions (316) and manages data processing within the enterprise system (300).

Data access within the computing system (302) is managed by the memory device (312), which includes RAM and ROM, and the storage device (314), which can be HDDs or SSDs. These components store and retrieve data required for system operations and applications (318).

Guiding the operations within the computing system (302) are the instructions (316). These software codes direct the processing device (310) in executing tasks and managing data flow.

The computing system (302) runs various applications and programs under segment (318), including a specialized program (320) for managing card benefits. These applications (318) facilitate the management of card benefits and other financial services within the enterprise system (300).

Internal communication within the computing system (302) is overseen by the intraconnect (322). This ensures efficient data transfer between the processing device (310), memory device (312), and storage device (314).

For external connections, the computing system (302) employs the communication interface (324). Data transfers are facilitated by the wireless communication device (326) and the wired device (328), such as Gigabit Ethernet ports. This interface (324) enables the computing system (302) to communicate with the network (330) and other connected devices such as external storage systems, cloud servers, and backup systems. External connections are crucial for accessing cloud services, external databases, and ensuring redundancy and data recovery.

### Network (330) and Interactions

The computer (198) and the external systems (192, 194, and 196) connect to the network (330), ensuring a fluid user experience across internal and external components. Examples of external systems include payment gateways, third-party financial services, and regulatory compliance systems. The network (330) facilitates data exchange between the mobile device (200), computing system (302), and external systems (192, 194, 196), supporting the seamless operation of digital banking and card benefit management.

Human agents (304) interface through the human agent device (306), which can range from advanced workstations to interactive terminals. These agents (304) interact with the enterprise system (300) to manage data, support users, and ensure efficient system operations. Collaboration with the virtual agent (308) in the enterprise system (300) aids in efficient data analysis and interactions. The virtual agent (308) processes data, supports decision-making, and enhances user interactions within the system.

FIG. 2 is a diagram of a feedforward network (301), in accordance with an embodiment of the present invention. The feedforward neural network (301) serves as a foundational structure for understanding and modeling complex patterns and relations within a given dataset. Unlike recurrent neural networks, the flow of information in a feedforward neural network (301) is unidirectional, ensuring that data moves from the input towards the output without any loopback.

### Components of the Feedforward Neural Network (301)

Input Layer (303): At the beginning of the feedforward neural network (301) lies the input layer (303). It is responsible for receiving and processing input data. Within this layer, there are multiple nodes (309). These nodes (309) represent individual data features or attributes. For example, in the context of displaying card benefits, the input nodes (309) could represent features such as card usage frequency, types of transactions (e.g., groceries, travel), and user preferences. Other examples include pixel values for image recognition or transaction details in a financial dataset. The number of nodes (309) typically corresponds to the number of input features in the dataset.

Hidden Layer (305): Following the input layer (303), the network comprises one or more hidden layers (305), with the hidden layer (305) being a primary example. Within the hidden layer (305), there exist multiple nodes (311). These nodes (311) are responsible for transforming the input data through a series of weights and activation functions. In the context of card benefits, the hidden layers (305) could analyze patterns such as identifying which benefits are most relevant to the user based on past usage or predicting future benefit utilization. For instance, it might detect that a user frequently uses travel-related benefits and thus prioritize displaying travel perks. Other examples include identifying edges and textures in image recognition or detecting spending habits in financial data. The transformed data is then propagated forward to the next layer. The purpose of the hidden layer (305) is to introduce non-linearity to the network, enabling it to capture and model complex relations in the dataset.

Output Layer (307): The terminal point of the feedforward neural network (301) is the output layer (307). It consists of multiple nodes (313) that generate the final predictions or classifications based on the transformed data from the preceding layers. In the context of card benefits, the output layer (307) might present the most relevant benefits to the user, such as suggesting the top three benefits that align with the user's spending patterns. Depending on the problem at hand, the output layer (307) can represent a single value (for regression tasks like predicting the most likely benefit to be used next) or multiple values (for classification tasks like categorizing user transactions).

Node Interactions: Each node in the input layer (303) interacts with every node (311) in the hidden layer (305). This interaction involves a weighted connection (315), where the data from the input node (309) is multiplied by a weight before it is passed on to the node (311) in the hidden layer (305). Similarly, every node (311) in the hidden layer (305) interacts with every node (313) in the output layer (307), again via weighted connections (315). For example, input data such as transaction type and frequency may be weighted and combined to determine the significance of various benefits in the hidden layers (305). These weighted combinations continue through the network layers, refining the predictions. It's imperative to note that while nodes between layers interact with one another, nodes within the same layer (be it input, hidden, or output) do not have any interactions amongst themselves.

Overall, the feedforward neural network (301) offers a robust architecture to model complex datasets by ensuring a streamlined and directed flow of information through its layers, from input to output. This structured approach allows the network to learn and generalize from data effectively, making it suitable for various tasks, including personalized display of card benefits, image recognition, financial forecasting, and natural language processing.

FIG. 3 depicts a visualization of a convolutional neural network (CNN) 400, in accordance with an embodiment of the present invention. The CNN (400) is a specialized neural network type tailored for processing and analyzing structured data. This includes applications such as image processing, exemplified by QR code scanning, and extends to domains like transaction pattern analysis where spatial relationships within the data are critical.

Input Layer 402: The starting point of the CNN (400) is the input layer (402). It consists of multiple nodes (414), each dedicated to processing input data. In the context of QR code scanning, these nodes (414) represent the pixel values of the captured image. For transaction data, these nodes (414) could process elements structured in a grid-like format, such as time-based spending habits or categorically organized transaction types, which can be visually and spatially analyzed.

Hidden Layers (404, 406, and 408): The CNN (400) includes three hidden layers (identified as 404, 406, and 408). These layers contain nodes (414) that capture and analyze features from the input data. For example, the first hidden layer (404) might detect basic spending patterns, while deeper layers (406 and 408) interpret more complex relationships, such as the correlation between spending categories and card benefits usage. This hierarchical processing is akin to how layers in image processing tasks detect and interpret features from simple to complex.

Output Layer (410): The culmination of the CNN (400) is the output layer (410), comprising multiple nodes (414). In QR code scanning, this layer outputs decoded information. In the context of analyzing card benefits, it could predict which benefits are most likely to appeal to the user based on their transaction patterns, offering outputs such as recommended benefits or personalized offers.

Node Interactions: Each node in the input layer (402) interacts with every node in the first hidden layer (404) via convolutional operations, which are particularly effective at capturing spatial and temporal dependencies in the data. This process is repeated through each layer until reaching the output layer (410), allowing the CNN to build a comprehensive understanding of the input data, whether it's pixel data from images or structured transaction data.

Overall, the CNN (400) excels at processing structured data, whether it's derived from visual inputs like images or from spatially and temporally organized transaction data. This capability makes it highly effective for tasks that require nuanced understanding of complex data relationships, such as recommending card benefits based on user behavior.

FIG. 4 depicts a detailed insight into a segment of the CNN (400) illustrated in FIG. 3, in accordance with an embodiment of the present invention. In particular, FIG. 4 depicts the specific interactions between the input layer (402) and the first hidden layer (404). This depiction emphasizes how convolutional layers process and filter inputs to extract relevant features, whether for decoding QR codes or analyzing transaction patterns

Hidden Layer (404) Nodes: The first hidden layer (404) includes multiple nodes, each capable of processing different aspects of the input data. In the case of QR code scanning, these nodes might focus on specific patterns within the code. For transaction data, these nodes might identify patterns that are predictive of user preferences for certain card benefits.

Weight Assignments: Weights in the CNN (400), such as those represented by identifiers (420) and (422), modulate the influence of each input node on the corresponding hidden nodes. These weights are adjusted during training to optimize the network's ability to accurately predict outcomes based on the learned data features.

Interactions between Input and Hidden Nodes: Connections between nodes in the input layer (402) and the hidden layer (404) dictate how information is processed and passed forward. These interactions are key to the CNN's (400) ability to adapt and learn from both visual data like QR codes and structured datasets like transaction records.

Importance of Weight Assignments: The adaptability and learning capabilities of the CNN (400) hinge on the proper adjustment of weights, allowing the network to emphasize or de-emphasize specific inputs to achieve accurate predictions across various applications, including personalized card benefit recommendations. Overall, the intricate mechanisms of node interactions within CNN (400), underscore how convolutional layers process inputs through a series of weighted connections. These connections are essential for the network's ability to discern and learn from both structured and unstructured data. By fine-tuning these weights through training, the CNN can effectively adapt to diverse data types, from visual information like QR codes to complex patterns in transaction data, enhancing its ability to make accurate predictions and offer personalized recommendations based on user behavior.

FIG. 5 depicts a diagrammatic representation of the weighted sum computation in a node of a CNN (500), in accordance with an embodiment of the present invention. In particular, FIG. 5 focuses on detailing the mechanism of weighted sum computation in a specific node of the CNN (500). This computational detail is paramount to understanding the underlying processes that enable the CNN (500) to perform sophisticated data transformations, pivotal in tasks like feature recognition. This process is especially critical in analyzing transaction patterns and card usage data to dynamically update and personalize card benefits displayed to the user.

CNN (500) offers a snapshot of an architecture where the spotlight is on the node (520) residing in a hidden layer. This representation serves to exemplify how individual nodes in the CNN (500) process incoming data from previous layers. In the context of the patent, such nodes could be analyzing transaction data to detect spending patterns relevant to card benefits.

Input Layer (502) and Respective Nodes: Input layer (502) houses several nodes (504, 506, 508, and 510) that serve as data feeders for the succeeding layers. Each node (504, 506, 508, and 510) has certain values representing features or patterns from the raw input data. In a card benefits system, these might include data points like transaction amount, merchant category, time of transaction, and user-selected preferences. It's these values that eventually get passed onto the nodes in subsequent layers.

Assigned Weights for Inputs: Each connection from the input nodes (504, 506, 508, and 510) to node (520) in the hidden layer has an associated weight. These weights (512, 514, 516, and 518) modulate the input values. In essence, these weights determine the significance or influence each input has on the node (520). During the network's training phase, these weights (512, 514, 516, and 518) undergo adjustments, ensuring that the network hones its capability to make accurate predictions or classifications. For example, weights (512, 514, 516, and 518) might be adjusted to prioritize users' preferred transaction types when predicting which card benefits to highlight.

Weighted Sum Computation at Node (520): The primary operation at node (520) is the computation of a weighted sum. This computation involves multiplying each input value from nodes (504, 506, 508, and 510) by their respective weights (512, 514, 516, and 518). The results of these multiplications are then aggregated to produce a single value. This value is the weighted sum, which acts as the node (520)'s processed input. Post this computation, the value typically undergoes an activation function, transforming it before it's passed onto nodes in subsequent layers. This step is crucial for assessing how different aspects of a user's spending behavior influence the selection of relevant card benefits.

Overall, FIG. 5 offers an insightful view into the nuanced computations occurring at a single node in a CNN (500). By detailing the weighted sum process and emphasizing the role of input weights, this representation elucidates the foundational arithmetic that drives CNNs, underscoring the network's ability to transform raw data into meaningful, processed information. This capability is integral to the personalized display of card benefits, ensuring that users receive the most relevant offers based on their individual transaction profiles.

FIG. 6 depicts a recurrent neural network (RNN) (600) utilized in machine learning, in accordance with an embodiment of the present invention. The RNN (600) is notable for its ability to incorporate past information into current computations, distinguishing them from traditional feedforward neural networks. This characteristic is particularly valuable for tasks involving sequential data or time series information, which could be applied to optimize card benefit offerings.

Structure of RNN (600): The RNN (600) includes an input layer (602), an output layer (608), and two hidden layers (604 and 606). The input layer (602) features nodes (610) that accept and transmit raw or pre-processed data into the RNN (600). For instance, these nodes (610) might handle sequences of transactions, identifying spending trends or frequent transaction categories that inform card benefit predictions. The output layer (608) contains nodes (612), responsible for presenting the final processed data or predictions, such as recommending card benefits tailored to user spending behaviors identified by the network.

Feedback Connector (618) and its Significance: One of the distinguishing features of RNN (600) is the feedback connector (618), which relays parameter data from the nodes (616) in the second hidden layer (606) back to the nodes (614) in the first hidden layer (604). The feedback mechanism provided by the feedback connector (618) enables the network's (600) recurrent nature, allowing past computations to dynamically influence current operations, enhancing the accuracy and relevance of benefit suggestions based on ongoing user activities.

Parameter Communication Across Layers: RNN (600) demonstrates flexibility in communicating parameters or other data between layers. For example, nodes from a subsequent layer might relay updated spending habit data back to earlier layers, refining the network's predictions over time. This functionality ensures that changes in user behavior are quickly incorporated into the benefit analysis, maintaining up-to-date recommendations.

Potential for Multiple Feedback Connectors: While FIG. 6 illustrates the use of feedback connector (618), RNN (600) can also include multiple feedback connectors. These additional connectors might link various node systems, enhancing the network's ability to handle complex, multi-dimensional data flows. For example, in a card benefits system, multiple feedback connectors could help track and analyze several user behaviors simultaneously, such as changes in spending patterns, location-based transactions, and frequency of benefit usage.

Overall, FIG. 6 highlights the specialized architecture of RNN (600), showcasing its recurrent capabilities through feedback connectors. This design equips the RNN (600) to handle sequential data effectively and is used for shaping current and future benefit offerings based on comprehensive analysis of past and present user data.

FIG. 7 depicts a schematic representation of artificial intelligence processing within an artificial intelligence program, in accordance with an embodiment of the present invention. Deep Neural Networks (DNNs) represent a subset of neural network architectures that comprise multiple layers, typically more than three, between the input and the output layers. This multi-layered configuration enables DNNs to model and process high-level abstractions of data, rendering them highly effective in various complex machine learning tasks. While tasks such as image recognition, speech recognition, and language translation have seen significant advancements, DNNs are equally potent in financial services for analyzing complex transaction patterns and customizing card benefits based on user behavior. FIG. 7 depicts a detailed schematic of an artificial intelligence programming system, labeled as system (750). At the heart of this system lies the AI processor (752), a dedicated processing device specifically tailored to operate artificial intelligence programs efficiently. Within the AI processor (752), there are distinct operational divisions, prominently the front-end sub-processor (754) and the back-end sub-processor (756). These sub-processors play crucial roles in the overall functioning of the AI system. The front-end sub-processor (754) is primarily vested with tasks like data pre-processing and feature extraction. In the context of card benefits, this might involve analyzing transaction data to identify spending habits, categories, and user preferences that form the foundational features for subsequent processing stages. The back-end sub-processor (756), on the other hand, delves deeper into the data, leveraging the features identified by the front-end sub-processor to make predictions about the most suitable card benefits or to classify transaction types for better user engagement and satisfaction. Accompanying the AI processor (752) is memory device (758), which serves as a reservoir for algorithms and computational instructions associated with both sub-processors. Moreover, system (750) is further equipped with an additional memory component, labeled as memory (760). This memory houses vital instructions essential for the smooth operation of the AI program, ensuring that the AI processor has a consistent reference for its tasks. Delving into the intricate details of the sub-processors, the front-end sub-processor (754) incorporates neural networks (766 and 768). These networks operate an AI algorithm (762), exemplified by feature recognition. Feature recognition, in essence, discerns discernible patterns or attributes within raw data that are paramount for subsequent data processing stages, such as identifying spending trends that influence card benefits optimization. In tandem, the back-end sub-processor (756) boasts of neural networks (770 and 772). These networks are instrumental in running an AI algorithm (764), which is primed to execute specific operations on the dataset relayed to it. Operations here could include data classification, regression analysis, or prediction tasks tailored to enhance the personalization of card benefits, ensuring that recommendations are both timely and contextually relevant.

Overall, FIG. 7 meticulously details the structure and operational dynamics of system (750), underscoring the pivotal roles of the AI processor, its sub-processors, and the neural networks within. This intricate system showcases the synergy between hardware and algorithms, enabling advanced AI operations and exemplifying the progressive strides in artificial intelligence and machine learning realms, particularly in the enhancement of financial services and personalized card offerings.

FIG. 8 depicts a flow chart depicting a method (800) for training a machine learning model, in accordance with an embodiment of the present invention. The diagram of the method (800) provides a comprehensive delineation of a methodological process encompassing the development and subsequent deployment of models within the vast domain of machine learning. Methodically charting out the integral sequences, FIG. 8 serves as an archetype for successful orchestration and realization of myriad machine learning projects, particularly in enhancing card benefit systems and customer engagement strategies.

User Initiation—Box (802): Box (802) stands as the initial touchpoint where a user—be it a financial analyst, a customer service AI, or a decision-support system—actively orchestrates, triggers, or sets into motion the machine learning procedure. For example, in the context of card benefits, this might involve initiating a new project to analyze spending patterns to tailor card offers.

Data Assimilation—Box (804): Transitioning to Box (804), this juncture serves as the epicenter for comprehensive data acquisition. In the context of a financial institution, data could range from transaction histories, customer demographic information, and past card benefit utilization, all collated and prepared for analysis.

Preprocessing of Data—Box (806): Box (806) delves into preprocessing, where the acquired data is streamlined and conditioned, making it suitable for detailed analysis. In the card benefits context, this might involve cleaning transaction data, categorizing expenditures, and encoding categorical variables for further machine learning processes.

Detection of Anomalies—Box (808): The journey proceeds to Box (808), which focuses on anomaly detection. In a card management system, this could involve identifying unusual spending patterns that may indicate fraud or misuse of card benefits, thereby triggering alerts to both customers and system managers.

Loop Initiation for Training and Testing—Box (810): Box (810) introduces the iterative process of training and testing, where historical data on customer transactions and benefit claims forms the foundation for developing predictive models aimed at optimizing benefit offerings.

Training of the Model—Box (812): Box (812) details the training of the model, where features like spending habits, frequency of transactions, and customer feedback on card benefits are used to refine predictive algorithms, enhancing their accuracy in personalizing offers.

Testing of the Model—Box (814): Next, Box (814) outlines the rigorous testing phase, where the trained model is evaluated against unseen data or recent transaction data to ensure its effectiveness in predicting card benefit preferences accurately.

Deployment of the Model—Box (816): Culminating the narrative, Box (816) heralds the deployment phase. Here, the validated models are integrated into the card management systems, actively used to automate and personalize card offers based on predictive insights derived from customer data.

Overall, embodied within FIG. 8 is a meticulously detailed, structured walkthrough of a machine learning model's lifecycle. This lifecycle is crucial for managing card benefits, from initial data gathering and model training to final deployment, ensuring that cardholders receive offers that are both timely and relevant to their spending behaviors.

Introduction to Digital Wallets: Before diving into the technical exposition of FIG. 9, it is important to provide an overview of a digital wallet. A digital wallet, often colloquially termed as an ‘e-wallet’, serves as an electronic device or online service that allows an individual to make electronic transactions. This digital platform can be linked to an individual's bank account, debit cards, credit cards, or even prepaid cards, facilitating a seamless bridge between the virtual and physical financial realms. Beyond financial transactions, digital wallets can securely store personal details and digital assets like tickets or boarding passes.

FIG. 9 depicts a front view of an example mobile device (900) that includes a user interface, in accordance with an embodiment of the present invention. FIG. 9 paints a vivid portrait of the front view of mobile device (900), a contemporary smartphone archetype. Equipped with multiple side buttons (902), mobile device (900) enables versatile interactions, including dedicated access to the digital wallet, customizable through settings for increased personalization and security.

Side Button—Component (902): The side button (902), a multifunctional facet of mobile device (900), may serve various roles from device locking to serving as a secure access point for the digital wallet. Programmable for security checks, it can activate biometric verifications like fingerprint scans, complemented by the potential for facial and voice recognition for enhanced security and ease of access. In addition, the side button (902) provides users with consistent access to the device's functionalities.

Multi-Factor Authentication Protocols: Integral to the device's security framework are advanced authentication protocols, which may include but are not limited to, biometric verification through a fingerprint reader (962), facial recognition via the integrated camera (964), and voice commands through the microphone (966), potentially interfacing with third-party applications akin to PayPal Wallet. With the increasing ubiquity of digital payments and the shift towards a cashless society, these wallets are becoming an indispensable tool for the modern consumer, safeguarded by robust multi-factor authentication that includes biometrics, personal identification numbers, and sophisticated AI models (968) for voice and facial recognition. A touch button (910) allows users to manually enter or verify information, such as security codes, not captured initially.

Near Field Communication (NFC) Capability and Online Purchase Function: The digital wallet's versatility extends to both physical and online domains, utilizing NFC for contactless in-store purchases and enabling straightforward online transactions. Such capabilities ensure that the digital wallet serves as a comprehensive tool for financial management and transactions.

FIG. 10 depicts a front view of an example mobile device (1000) that includes a camera (1018) for scanning a card (1016), in accordance with an embodiment of the present invention. Digital Wallet Setup Process: Central to FIG. 10, the digital wallet setup process is optimized through the camera (1018), which functions dually as a card scanner, capturing card details from the card (1016) for easy addition to the digital wallet, and as a means for facial recognition during the security verification process. The camera's (1018) dual-purpose nature streamlines user interaction and system complexity. Additionally, users can add cards (1016) by manually entering the card details, which includes inputting the card number, expiration date, and card verification value (CVV) code. Another method involves integrating the digital wallet with the user's bank or financial institution app, which can directly transfer card information to the wallet, simplifying the setup process.

Data Entry and Verification: Following the card scanning process by the camera, a touch button (1010) allows users to manually enter or verify information, such as security codes, not captured initially. For manually entered card details (1014), users are prompted to confirm all entered information, including card number, expiration date, and CVV code. When adding cards through financial institution integration, the wallet prompts the user to verify the linked account information, ensuring accuracy and security. This verification process may include entering a one-time password (OTP) sent via SMS or email, confirming the card's addition to the wallet. These steps integrate seamlessly with multi-factor security protocols, ensuring that the digital wallet remains a secure and user-centric platform. The digital wallet setup might also involve a step where the user can set preferences for automatic benefit updates or notifications, ensuring they are always informed of the best card to use for specific transactions to maximize rewards and benefits.

Data Storage: Once a card (1016) is scanned and the card details (1014) are obtained by the mobile device (1000), the card details (1014) are verified and stored to a cloud server (1070) as stored object information (1072).

FIG. 11 depicts a front view of an example mobile device (1100) that includes a GUI with a digital wallet (1148) depicted on the Digital Wallet Purchase Screen (1150) in accordance with an embodiment of the present invention. In particular, the GUI depicts an example digital wallet purchase screen display (1150), which enables users to select and confirm their payment options. The GUI depicted by the digital wallet purchase screen (1150) serves as a virtual platform that provides users with the ability to manage and execute digital transactions using virtual objects (i.e., digitized cards) stored within the digital wallet. The wallet purchase screen (1150), a user-centric interface designed to streamline the digital purchasing experience. This interface allows users to quickly access stored cards, view benefits, and make informed decisions during transactions.

Emphasized Display of Selected Card: Central to the wallet purchase screen (1150) is the virtual card image (1152) of a virtual card stored to the digital wallet (1148). This digital representation of the virtual card image (1152) portrays the physical card a user intends to use for the transaction. When a transaction is initiated, the card chosen by the user is vividly displayed, ensuring clear understanding and confirmation of the card in use for the transaction.

Storing and Showcasing Multiple Cards: The versatility of the digital wallet (1148) permits users to store and manage an array of cards, as evidenced by the depiction of multiple cards (1160). While the virtual card image (1152) dominates the screen, the other stored cards, represented by multiple cards (1160), are shown as condensed icons, perhaps aligned along the screen's edge, signifying alternative financial options within the wallet.

Transaction Facilitation via Transmitter: Integral to the purchasing mechanism is the transmitter (1154). Embedded within mobile device (1100), the transmitter (1154) oversees the secure wireless communication necessary for digital transactions. Utilizing technologies like NFC (Near Field Communication), the transmitter (1154) ensures the secure relay of transaction details to the recipient terminal. For example, when making an in-store purchase, the transmitter (1154) securely communicates with the merchant's terminal to process the payment using the selected card.

Displaying Card Attributes: The digital wallet purchase screen (1150) diligently incorporates card information (1158), which might include specifics like the card's expiration or the card type (credit/debit), is displayed, offering users an overview before finalizing a transaction.

Workflow of Digital Wallet Transaction: Engaging in a transaction via the digital wallet, as portrayed in FIG. 11, begins as the user activates the digital wallet (1148) application on mobile device (1100). Users can then choose a card from the roster of multiple cards (1160) or opt for a previously set default card. Once the card is selected and presented as the virtual card image (1152), users can proceed to the transaction phase. The transmitter (1154) interacts with the merchant's terminal, and upon user's authorization, processes the transaction details, culminating in a successful purchase. By shedding light on the nuanced steps of a digital wallet transaction, FIG. 11 encapsulates the optimized capabilities of the mobile device (1100) in facilitating diverse digital transactions.

FIG. 12 is a block diagram of an example system-level architecture (1200), in accordance with an embodiment of the present invention. The example architecture (1200) outlines the enterprise system's potential role in managing and operating the digital wallet, illustrating the interaction between various system components for enhanced data flow and security as well as populating the digital wallet with card details and images.

Introduction to System Architecture Facilitating Digital Wallet Operation: FIG. 12 reveals the intricate block diagram of the architecture (1200), conceived as a pivotal part of the enterprise system (see enterprise system 300 of FIG. 1). This system framework is specifically delineated to efficiently operate and manage digital wallets, further emphasizing the strategic coordination among its key components to uphold functionalities such as populating the digital wallet with card details and images.

The Role of Repository and Database in Information Management: Centrally positioned within the architecture is the Repository (1202), which houses the Database (1204). This consolidated storage solution is meticulously designed to handle vast amounts of structured data, ensuring that all pertinent card information, transaction logs, and user-related data remain organized, easily accessible, and securely stored. The Repository (1202) and Database (1204) are interconnected with the Backend Server (1206) through a bidirectional interface, facilitating dynamic data exchange essential for real-time operations.

Backend Server: The Operational Backbone: Positioned as the heart of processing operations, the Backend Server (1206) encapsulates the Processor (1208), Memory Device (1212), and Communication Interface (1210). This server administers and oversees the majority of data processing, retrieval, and management tasks. Within this server, the Processor (1208) is tasked with analyzing, processing, and executing commands essential for the digital wallet's operation, including populating the wallet with real-time card data and images, and executing security protocols.

Communication Interface: Bridging External Connections: The Communication Interface (1210), integrated within the Backend Server (1206), serves as the gateway for encrypted, stable, and high-speed data transmissions, be it for card information updates, transaction confirmations, or user notifications. This interface (1210) is crucial for maintaining seamless communication between the digital wallet and external systems, ensuring that relevant information is promptly reflected in the wallet.

Ensuring Memory Storage and Quick Retrieval: Also located within the Backend Server (1206), the Memory Device (1212) facilitates temporary storage for quick access and retrieval. This includes caching user preferences, temporarily holding transaction data for quick processing, or storing frequently used card details.

Dynamic Processing via Dedicated Processor: The Processor (1208), within the Backend Server (1206), possesses advanced capabilities that include analyzing, processing, and executing commands that are crucial for the operation of the digital wallet, reflecting a significant augmentation of the computational prowess of the architecture (1200).

Concluding Insights on System Architecture: The vivid depiction in FIG. 12, articulating the architecture (1200), underscores the meticulous design behind the enterprise system (see enterprise system 300 of FIG. 1), catering to the evolving needs of the digital wallet. Each block, be it for storage, processing, or communication, works in symphony, ensuring that users of the digital wallet experience seamless, secure, and efficient operations.

In one embodiment of the invention, the digital wallet system compares benefits between various cards that offer monetized cashback, where cashback are given as a percentage of the purchase amount converted into monetary value. Upon categorizing the transaction, such as groceries or dining, the system calculates the monetary return for each card by applying its respective cashback percentage to the transaction amount. The system then selects the card that offers the highest monetary return, thereby optimizing the financial benefit from the transaction automatically. For example, if Card A offers 2% cashback on groceries and Card B offers 3% cashback on groceries, the system will select Card B for grocery purchases to maximize the cashback benefits.

In another embodiment of the invention, the digital wallet system compares cashback rewards between various cards that offer rewards points convertible to cashback, focusing specifically on cards where the monetary value of the points is uniform across all uses. This comparison includes cards offering direct monetized cashback and those with reward points that consistently convert to an equivalent cash value, whether used for travel bookings, redeemed for gift cards, or converted directly to cashback. The system retrieves the latest conversion rates for these points from bank feeds, manual user inputs, third-party sources, or a backend database that is periodically updated. After evaluating the monetary value of rewards for each applicable card in a transaction, the system selects the card that offers the highest financial return. For instance, if a user has two options for a $100 purchase, where Card A provides points equivalent to $2 and Card B provides points that are equivalent to $3 when converted, the system will choose Card B to maximize the user's financial benefit from the purchase.

In another embodiment of the invention, when user preferences are explicitly set within the digital wallet, the system integrates these preferences into its reward optimization strategy. This prioritization becomes particularly significant in scenarios where different cards offer various types of rewards that are not directly comparable, such as some cards providing monetized cashback and others offering reward points that have a higher value when redeemed at specific merchants or for certain services. For instance, if a user has indicated a preference for travel rewards due to frequent travel, the system will prioritize cards that offer enhanced airline miles or hotel points when making purchases related to travel, over those offering standard cashback. This user-defined setting ensures that the system aligns its selections not just based on the highest monetary value but also in accordance with the user's lifestyle and spending goals. Additionally, if a user frequently shops at designated retailers or online platforms that offer special point multipliers or exclusive discounts with certain cards, the system will favor these cards when transactions occur at those merchants. This approach maximizes the financial return and personalizes the shopping experience by leveraging rewards that provide the greatest perceived value to the user.

In this embodiment of the invention, the digital wallet system evaluates rewards and benefits across cards that offer both types of rewards—those that provide reward points which may be more valuable in specific redemption contexts and those that provide tangible but non-financial value, such as extended warranties, rental collision insurance, 0% interest, or low-interest options. This embodiment also encompasses comparisons among cards solely offering tangible non-financial benefits. The system assesses which card offers the most substantial real-world advantages for specific user behaviors and needs. For example, if a user frequently rents cars, a card with superior rental collision insurance could be prioritized over others, even if another card provides additional benefits like extended warranties or low-interest terms. This comprehensive comparison ensures that the selected card maximizes practical advantages, aligning closely with the user's specific lifestyle needs and providing the most relevant benefits.

In another embodiment of the invention, if the system is unable to determine which card offers the most advantageous benefits for a particular transaction—due to reasons including, but not limited to, incomplete data or closely competing benefits that are difficult to quantify—it will revert to using a default card. This default card is typically one that the user has previously designated as their preferred choice for unspecified or general transactions. Additionally, the system informs the customer when it defaults to this card, ensuring the user is aware that the transaction might not be utilizing the most beneficial card available. This protocol ensures transactional efficiency while keeping the user informed about the decision-making process.

In another embodiment of the invention, the system proactively alerts the customer if they select a card that offers a lower cashback benefit for a particular transaction, highlighting the potential loss in maximizing the benefits. This alert is displayed through various visual representations within the digital wallet, such as icons, color-coded warnings, or pop-up messages. These visual cues are designed to be immediately noticeable and provide clear, concise information, helping the user to reconsider their choice and opt for a card that offers greater cashback or rewards for that specific transaction. This feature enhances user awareness and assists in making more informed financial decisions directly within the transaction process.

In another embodiment of the invention, the system integrates spending limits associated with rewards on various cards to automatically optimize reward calculations. For instance, a card may offer 5% cash back on grocery purchases up to a spending limit of $2500 per quarter, with the rate dropping to 1% thereafter. The system tracks the user's grocery spending on this card by either aggregating transactions processed through the digital wallet or directly connecting to the bank to retrieve current spending against the card's limit. This is done by providing the bank with details of the card and requesting up-to-date transaction data. When processing a new transaction, if the system recognizes that the purchase will exceed the $2500 threshold, it recalculates the expected cash back based on the lower rate. This recalculated reward is then considered in the algorithm that selects the default card for the transaction, ensuring the selection is based on which card provides the most substantial benefits under the current spending conditions. This approach enables the user to maximize rewards effectively, leveraging the system's capacity to manage complex calculations without manual input.

In another embodiment of the invention, the system takes into account both the reward structures and the credit limits of various cards to optimize transaction processing. For instance, consider a scenario where a card provides 5% cash back on all purchases but has a credit limit of $3000. If a customer plans a transaction of $3500, this card, despite its high rewards, would be ineligible due to the credit limit constraint. The system assesses the customer's current outstanding balance and the transaction amount against each card's credit limit. It automatically excludes any card where the transaction would exceed the credit limit, even if the rewards are substantial. Instead, the system selects the next available card that offers the best rewards without breaching the credit limit. This method ensures transactions are processed smoothly without risk of denial due to limit overreach, thereby maintaining efficient financial management and maximizing reward benefits within the given constraints.

In another embodiment of the invention, if the system must choose between two cards offering similar cashback rewards, it will assess additional benefits that are not directly monetary, such as warranty extensions, to determine the optimal card. For instance, if two cards both offer 2% cashback on purchases but one includes an extended warranty on electronics and the other does not, the system will prioritize the card with the warranty extension for purchases related to electronics. This method ensures that the card selected provides not only financial returns but also valuable additional protections that enhance the overall benefit to the user.

In another embodiment of the invention, when a customer expresses interest in minimizing interest charges due to their intention to carry a balance over time rather than paying in full each month, the system integrates this preference. Annual Percentage Rate (APR) is the yearly interest rate charged on outstanding credit card balances, which are the amounts of money owed that have not yet been paid off. A lower APR means less interest accrues on these outstanding balances each month, directly affecting how much the customer ultimately pays.

The system retrieves information about APRs and other relevant fees such as annual fees, late payment fees, and balance transfer fees from the credit card issuers through direct connections to banks, through APIs that provide financial data, or from publicly available information on the card. This comprehensive data enables the system to analyze not only the APR but also additional costs that might impact the overall cost-effectiveness of carrying a balance. Using this information, the system compares both the interest savings potential and cashback benefits across various cards. For example, if Card A offers a lower APR of 15% with minimal cashback and Card B offers a higher cashback rate but with a 20% APR, the system calculates which card offers the most cost-effective solution for the user, considering their projected balance carrying pattern. The system then advises the customer on the optimal card to use, effectively balancing the benefits of lower interest rates against potential rewards.

In another embodiment of the invention, the system utilizes the customer's geographical location to accurately predict the store where the customer intends to use their credit card. Upon initiating a transaction, the system accesses the customer's location data and interfaces with third-party services like Google Maps to pinpoint the likely store or merchant the customer is visiting. It retrieves the cashback rewards information specific to that merchant from a database, which may include exclusive offers or higher cashback percentages available only at certain locations. Once the potential store is identified, the system calculates the rewards for each card that the customer holds, compares these rewards, and automatically selects the card that offers the maximum rewards for the purchase at that location. To further enhance the accuracy of this system, customers are given the option to confirm whether the identified store matches their intended purchase location. This validation step not only confirms the appropriateness of the rewards calculated but also adjusts the system's future predictions and recommendations based on the customer's feedback. This proactive approach streamlines the process of automatically selecting the most beneficial card for each transaction based on geographical advantages.

In another embodiment of the invention, customers have the option to specify their reward preferences within the digital wallet system. For instance, some customers might prioritize earning airline points due to frequent travel, while others may prefer to maximize monetary cashback for general spending. The system allows customers to set these preferences explicitly, designating their priority reward categories. When conducting transactions, the system automatically takes these preferences into account and selects the default card that optimizes rewards according to the customer's specified priorities. This personalized approach ensures that customers not only use the most financially advantageous card for each purchase but also align their spending with their lifestyle and rewards goals.

In another embodiment of the invention, the system manages cashback offers that require manual activation by the customer on a periodic basis. For some credit cards, top-tier cashback rates are only available after the customer actively opts into the offer through the card's interface by confirming or tapping a button. If this activation step is not completed, the card defaults to a lower cashback rate. To assist customers in maximizing their rewards, the system connects to the banking system to verify whether the cashback offer has been activated for each reward cycle. If the system detects that the offer has not been activated, it will issue a warning message to the customer. This message informs them that the higher cashback rate is currently inactive, and they are missing out on potential rewards. By alerting the customer, the system ensures they are aware of the need to activate the offer to receive the anticipated cashback benefits. If the system is unable to determine whether the cashback offer has been activated or not, it will proceed to use the card while providing a warning message to the customer. This message will inform the customer that the system is operating under the assumption that the cashback offer has been activated, thereby ensuring transparency to the customer and allowing the customer to take alternative or other necessary actions.

The system identifies the benefits associated with each card using several methods. Firstly, the system can utilize the full or partial card number to query the backend system where the benefits information is stored. Secondly, the system can use an image of the card to extract the bank and card name, then query the backend system to retrieve the benefit details. Additionally, if the benefits information is stored in a separate database from the bank's database, the backend system will connect with the bank's database and the separate database via API calls to get updated benefits. This can be done individually for single cards or through periodic bulk file transfers that include benefits information for multiple cards associated with the same bank.

Moreover, the system can use merchant code matching to identify potential benefits during transactions, leveraging user profiles and preferences for personalized benefits, and connect directly to the card issuer's database for real-time or periodic updates. Integration with third-party data aggregators provides a centralized source of benefits data by collecting and managing information from multiple card issuers and loyalty programs. The system can also interface with customer service platforms, allowing manual updates to benefits information when automated methods are not possible. Additionally, the system can use subscription service APIs to retrieve detailed benefits information specific to premium cards, such as exclusive travel perks or higher cashback rates offered by the subscription services. Furthermore, querying loyalty program databases ensures that benefits associated with loyalty points, rewards, and other program-specific perks are accurately displayed.

In certain embodiments of the invention, when a cardholder initiates a transaction on an online platform, such as a retail, travel, or any other type of website, and selects a digital wallet for payment, the digital wallet is configured to recognize the platform from which the transaction is initiated. This recognition can occur through mechanisms that detect the URL or through API calls that convey the platform's identity. Once the platform is identified, the digital wallet consults a database to retrieve specific benefits applicable to each card stored within the wallet for transactions conducted on this platform. The wallet then automatically selects a card with maximum reward for the transaction.

This invention, through its various embodiments and implementations, thus presents a solution to the challenge of underutilized card benefits. By providing a system and method for automatically selecting the card with the maximum benefits during the transaction, the cardholder's experience is greatly enhanced. The detailed descriptions provided herein are illustrative, and variations and modifications within the scope of this invention would be apparent to those skilled in the art.

The systems and methods disclosed herein have been described with a degree of specificity for the purposes of illustration. It should be understood that numerous modifications, variations, and adaptations may be made by those skilled in the art without departing from the spirit and scope of the invention.

The automatic selection of cards with maximum benefits during a transaction serves not only as a tool to enhance the cardholder's experience but also provides indirect benefits to card issuers. It can improve customer loyalty, increase card usage, and potentially enhance revenue through increased transaction volume.

For digital wallet operation systems (e.g., PayPal, Google Wallet™, Apple Wallet®, etc.), the system could be introduced gradually, starting with a pilot program for a select group of cardholders. This approach allows issuers to gather feedback and make necessary adjustments before a full rollout, ensuring the system is adaptable and can be refined based on user feedback and evolving needs.

For virtual cards, selecting the card with maximum benefits operates efficiently without compromising the performance of the app or digital wallet where the card is hosted. Regular updates to the display's software ensure compatibility with new operating systems and devices, integrating advanced features or improvements to maintain usability and engagement.

Overall, the disclosed systems and methods provides a comprehensive, flexible, and user-friendly solution for selecting the card with maximum benefits automatically during a transaction. It significantly enhances the cardholder's experience and offers substantial benefits to card issuers, potentially increasing the card usage, customer satisfaction and loyalty.

FIG. 13 depicts a block diagram of an example method 1300, in accordance with an embodiment of the present invention. At block 1305, the system determines that an optimization operation for data base querying is being initiated. The optimization operation is the selection of a credit or debit card based on determining which credit or debit card would be optimal for a specific transaction by comparing and evaluating a comprehensive range of benefits, including but not limited to a resource distribution (e.g., cashback), a travel-related advantage (e.g. travel perks), protection coverage (e.g., insurance coverage), extended security term (e.g., extended warranties), exchange protection (e.g., purchase protection), concierge services, and advanced fraud protection, thereby ensuring the card chosen maximizes the cardholder's benefits for each specific transaction, whether online or in-store. In some instances, the determining is at least partially triggered by a user accessing, via a user device, a digital wallet associated with a plurality of virtual objects (i.e., credit or debit cards). In some embodiments, the determining that the optimization operation for data base querying is being initiated is based on a user setting authorizing the optimization operation, wherein the user setting is configurable to initiate the optimization operation for a user-defined subset of exchange operations such that the optimization operation is bypassed and a default virtual object is selected when if the user setting for initiating the optimization operation is not satisfied. In one example, the system includes a customization feature that allows users to designate specific transactions to always default to a chosen card, thereby bypassing the standard benefit-based selection logic for these tagged transactions.

In some embodiments, the method 1300 further includes accessing geolocation data of a current geolocation of the user device and evaluating the geolocation data as part of the optimization operation to determine (i) whether the exchange operation is occurring at an in-person location, and (ii) based on the exchange operation occurring at the in-person location, identifying the in-person location, wherein the selecting which of the plurality of virtual objects optimizes the improvements includes predicting that the selected virtual object provides the greatest value at the in-person location. Further, the method 1300 may include transmitting an alert to the user device recommending the selected virtual object, wherein the applying the selected virtual object to the exchange operation is based on receiving a user response to the alert that selects the selected virtual object. In one particular example, the system alerts customers when a better card is available based on geographic location during an in-store transaction. This alert mechanism evaluates the benefits of alternative cards in the digital wallet and notifies the customer if a card offers superior rewards for the transaction at that specific location.

At block 1310, the system receives item data associated with at least one item, the at least one item being obtainable by transferring one or more resources to an external location. In some embodiments, the at least one item includes a product or service obtainable from either an online source or an in-person location.

At block 1315, the system queries one or more databases storing stored object data (e.g. data of at least one of credit card benefit information, extended warranty data, travel-related advantage data, annual percentage rate (APR) data associated with an interest rate applicable to any of the plurality of virtual objects, card usage rate data, user-defined settings data, etc.) related to a plurality of virtual objects (i.e., a plurality of digital credit or debit cards), the one or more resources being associated with one of the plurality of virtual objects. In some embodiments, the plurality of virtual objects includes a default virtual object for when the at least one item is obtained from an online source as indicated by the stored object data of the default virtual object, the default virtual object being selected as the selected virtual object due to the ascertaining of the item data assigning a greater weight to an item attribute indicating the exchange operation is being performed online. In some instances, an alternative virtual object is recommended as the selected virtual object instead of the default virtual object due to the ascertaining of the item data assigning a greatest weight to an alternative item attribute the alternative virtual object being recommended by providing an electronic notification to a user device of a user prior to applying the selected virtual object to the exchange operation. For example, when a card with superior benefits for a specific online purchase is available in the digital wallet, encouraging the use of the card with superior benefits over other cards with lesser rewards for that transaction. In some embodiments, the method 1300 receives one or more user-defined settings for assigning a greater weight to certain attributes of the stored object data, at least one setting of the one or more user-defined settings being associated with a duration of applicability of the greater weight. In some instances, the system allows customers to set and prioritize specific rewards on selected cards for a defined or indefinite duration, enabling tailored management of benefit accumulation.

In some embodiments, the plurality of virtual objects includes a default virtual object, the default virtual object being ascertained based on the default virtual object having a highest usage frequency relative other virtual objects of the plurality of virtual objects. In particular, the system would select the default card based on the cardholder's higher shopping usage. In some embodiments, if two cards offer the same rate of rewards, the system selects the card that provides additional benefits, such as extended warranties or travel perks, to maximize overall value for the transaction. In some embodiments, if all cashback rates are equivalent, the system selects a card for usage based on additional criteria such as lower APR, fewer recent uses to balance card utilization, or preferred card settings specified by the customer. For example, in one embodiment the system selects a card for transactions by evaluating the Annual Percentage Rates (APR), which are the yearly interest rates charged on carried balances, choosing the card with the lowest APR to minimize interest costs for the user. In some embodiments, the selected virtual object is chosen due to the credit card limit or the bank account balance limit. In some embodiments, the plurality of virtual objects that are included in the optimization operation is selectable such that a certain virtual objects are excludable from the optimization operation.

At block 1320, the system ascertains, from the stored object data and the item data, and select which of the plurality of virtual objects optimizes improvements, the ascertaining and selecting being included as part of the optimization operation. In accordance with one embodiment of the invention, the card selected for defaulting in online purchases is determined based on the most advantageous combination of benefits tailored to the specific nature of the transaction or the relevant online service involved. This evaluation considers factors such as cashback rates, travel perks, insurance benefits, and extended warranties, ensuring the card chosen optimizes the cardholder's benefits specific to the transaction across diverse online platforms, whether for shopping, booking travel, renting vehicles, or paying bills. In some embodiments, the improvements include at least one of a resource distribution (i.e., a cashback reward), a travel-related advantage, an insurance coverage, and an extended security (e.g., warranty) term. In particular, system evaluates all available rewards, including non-cash benefits such as travel perks and insurance, when determining the most advantageous card for a transaction. In some embodiments, the system trains an artificial intelligence engine to predict which of the plurality of virtual objects optimizes the improvements, the training including iteratively predicting a target variable as part of a training and testing loop and adjusting weights applied to input nodes during each iteration to improve predictability of the target variable. Further, the system deploys the trained machine learning model and applies the stored object data and the item data to the artificial intelligence engine as part of the ascertaining in order to select the selected virtual object for the exchange operation. Accordingly, the system may utilize an Artificial Intelligence (AI) algorithm to automatically calculate the optimal rewards for each transaction based on the card's limits, usage, and applicable benefits. In some embodiments, the ascertaining evaluates aspects of the stored object data that include at least one of (i) past usage patterns of each of the plurality of virtual objects, the past usage patterns including seasonality fluctuations, (ii) virtual object balances associated with each of the plurality of virtual objects, and (iii) usage fees applied to any of the plurality of virtual objects. In some embodiments, the system includes a predictive analytics feature that suggests the optimal card based on past transaction patterns, seasonal spending habits, and upcoming payment deadlines. In some embodiments, the system offers real-time analysis of transaction fees associated with each card and incorporates this data into the default card selection process.

In some embodiments, the system access geolocation data of a current geolocation of a user device to determine a current sovereign entity or geographic subdivision of the sovereign entity and evaluates the geolocation data as part of the optimization operation to determine whether the current sovereign entity or the geographic subdivision of the sovereign entity impacts the improvements available prior to selecting the selected virtual object. For instance, in one example the system dynamically adjusts the default card to be used in the transaction based on geographic location, optimizing for local rewards or currency benefits in international transactions.

At block 1325, the system applies a selected virtual object from the plurality of virtual objects to an exchange operation to transfer the one or more resources to the external location. In some embodiments, applying of the selected virtual object to the exchange operation is in response to a manual input received via a user device. In other embodiments, applying of the selected virtual object to the exchange operation is automatic based on a selected default setting, and wherein the stored object data for each of the plurality of virtual objects is dynamically updated prior to initiating the ascertaining such that the selected default setting is modified in accordance with updates to the stored object data. For example, in one embodiment the system provides customers with the option to activate or deactivate the automatic selection of the card offering the highest benefits for each transaction. In another example, the system dynamically updates the default card selection based on real-time changes in card benefits to ensure the most advantageous terms are always applied to transactions. In some examples, the system considers the benefits of a newly added card alongside existing cards in the digital wallet to dynamically update the default card selection at the time of each transaction, ensuring the most beneficial card is used based on current available options. In one embodiment, when a card is removed from the digital wallet, the system reassesses the benefits of the remaining cards to dynamically update the default card selection at the time of each transaction, ensuring the card with the most advantageous benefits is used. In another embodiment, when the benefits of any card within the digital wallet are updated, the system dynamically reassesses and updates the default card selection at the time of each transaction, ensuring the card with the newly updated and most advantageous benefits is used.

In some embodiments, the method 1300 provides, via a user device, a prompt to manually select the selected virtual object based on the ascertaining determining that the improvements are equivalent for multiple virtual objects of the plurality of virtual objects. According to one embodiment, if all reward benefits are equivalent across cards, the system prompts the customer to manually select a card, allowing them to choose based on personal preference or additional card features.

FIG. 14 depicts a block diagram of an example method 1400, in accordance with an embodiment of the present invention. At block 1405, the system determines that an optimization operation for data base querying is being initiated. At block 1410, the system receives item data associated with at least one item, the at least one item being obtainable by transferring one or more resources to an external location. At block 1415, the system queries one or more databases storing stored object data related to a plurality of virtual objects, the one or more resources being associated with one of the plurality of virtual objects. Further, at block 1420, the system ascertains, from the stored object data and the item data, and selects which of the plurality of virtual objects optimizes improvements, the ascertaining and selecting being included as part of the optimization operation.

Certain aspects of the invention are depicted with reference to flowcharts or block diagrams. It is to be understood that each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs.

The structures, materials, acts, and equivalents of all means or step plus function elements in the claims below, if any, are intended to include any structure and/or material for performing the function in combination with other claimed elements. The descriptions are not intended to be exhaustive or limited to the invention in the form disclosed. Many modifications and variations will be apparent to those of ordinary skill in the art without departing from the scope and spirit of the invention.

What is claimed is:

1. A computing system for data base querying of stored object data structures for optimized data management, the computing system comprising:
at least one processor;
a communication interface communicatively coupled to the at least one processor; and
a memory device storing executable code that, when executed, causes the processor to:
determine that an optimization operation for data base querying is being initiated;
receive item data associated with at least one item, the at least one item being obtainable by transferring one or more resources to an external location;
query one or more databases storing stored object data related to a plurality of virtual objects, the one or more resources being associated with one of the plurality of virtual objects;
ascertain, from the stored object data and the item data, and automatically select which of the plurality of virtual objects optimizes improvements, the ascertaining and selecting being included as part of the optimization operation; and
apply a selected virtual object from the plurality of virtual objects to an exchange operation to transfer the one or more resources to the external location.

2. The computing system of claim 1, wherein the determining is at least partially triggered by a user accessing, via a user device, a digital wallet associated with the plurality of virtual objects.

3. The computing system of claim 2, wherein the executable code, when executed, further causes the processor to:
access geolocation data of a current geolocation of the user device;
evaluate the geolocation data as part of the optimization operation to determine (i) whether the exchange operation is occurring at an in-person location, and (ii) based on the exchange operation occurring at the in-person location, identifying the in-person location, wherein the selecting which of the plurality of virtual objects optimizes the improvements includes predicting that the selected virtual object provides the greatest value at the in-person location; and
transmit an alert to the user device recommending the selected virtual object, wherein the applying the selected virtual object to the exchange operation is based on receiving a user response to the alert that selects the selected virtual object.

4. The computing system of claim 1, wherein the improvements include at least one of a resource distribution, a travel-related advantage, protection coverage, an extended security term, exchange protection, concierge services, and advanced fraud protection.

5. The computing system of claim 1, wherein the at least one item includes a product or service obtainable from either an online source or an in-person location.

6. The computing system of claim 1, wherein the plurality of virtual objects includes a default virtual object for when the at least one item is obtained from an online source as indicated by the stored object data of the default virtual object, the default virtual object being selected as the selected virtual object due to the ascertaining of the item data assigning a greater weight to an item attribute indicating the exchange operation is being performed online.

7. The computing system of claim 6, wherein an alternative virtual object is recommended as the selected virtual object instead of the default virtual object due to the ascertaining of the item data assigning a greatest weight to an alternative item attribute the alternative virtual object being recommended by providing an electronic notification to a user device of a user prior to applying the selected virtual object to the exchange operation.

8. The computing system of claim 1, wherein the applying of the selected virtual object to the exchange operation is in response to a manual input received via a user device.

9. The computing system of claim 1, wherein the applying of the selected virtual object to the exchange operation is automatic based on a selected default setting, and wherein the stored object data for each of the plurality of virtual objects is dynamically updated prior to initiating the ascertaining such that the selected default setting is modified in accordance with updates to the stored object data.

10. The computing system of claim 1, wherein the executable code, when executed, further causes the processor to receive one or more user-defined settings for assigning a greater weight to certain attributes of the stored object data, at least one setting of the one or more user-defined settings being associated with a duration of applicability of the greater weight.

11. The computing system of claim 1, wherein the executable code, when executed, further causes the processor to:
train an artificial intelligence engine to predict which of the plurality of virtual objects optimizes the improvements, the training including iteratively predicting a target variable as part of a training and testing loop and adjusting weights applied to input nodes during each iteration to improve predictability of the target variable;
deploying the trained machine learning model; and
applying the stored object data and the item data to the artificial intelligence engine as part of the ascertaining in order to select the selected virtual object for the exchange operation.

12. The computing system of claim 1, wherein the stored object data include data of at least one of extended warranty data, travel-related advantage data, annual percentage rate (APR) data associated with an interest rate applicable to any of the plurality of virtual objects, card usage rate data, user-defined settings data, and a maximum limit applied to the plurality of virtual objects.

13. The computing system of claim 1, wherein the executable code, when executed, further causes the processor to provide, via a user device, a prompt to manually select the selected virtual object based on the ascertaining determining that the improvements are equivalent for multiple virtual objects of the plurality of virtual objects.

14. The computing system of claim 1, wherein the plurality of virtual objects includes a default virtual object, the default virtual object being ascertained based on the default virtual object having a highest usage frequency relative other virtual objects of the plurality of virtual objects.

15. The computing system of claim 1, wherein the ascertaining evaluates aspects of the stored object data that include at least one of (i) past usage patterns of each of the plurality of virtual objects, the past usage patterns including seasonality fluctuations, (ii) virtual object balances associated with each of the plurality of virtual objects, and (iii) usage fees applied to any of the plurality of virtual objects.

16. The computing system of claim 1, wherein the executable code, when executed, further causes the processor to:
access geolocation data of a current geolocation of a user device to determine a current sovereign entity or geographic subdivision of the sovereign entity; and
evaluate the geolocation data as part of the optimization operation to determine whether the current sovereign entity or the geographic subdivision of the sovereign entity impacts the improvements available prior to selecting the selected virtual object.

17. The computing system of claim 1, wherein the determining that the optimization operation for data base querying is being initiated is based on a user setting authorizing the optimization operation, wherein the user setting is configurable to initiate the optimization operation for a user-defined subset of exchange operations such that the optimization operation is bypassed and a default virtual object is selected when if the user setting for initiating the optimization operation is not satisfied.

18. The computing system of claim 1, wherein the plurality of virtual objects that are included in the optimization operation is selectable such that a certain virtual objects are excludable from the optimization operation.

19. A computer-implemented method, comprising:
determining that an optimization operation for data base querying is being initiated;
receiving item data associated with at least one item, the at least one item being obtainable by transferring one or more resources to an external location;
querying one or more databases storing stored object data related to a plurality of virtual objects, the one or more resources being associated with one of the plurality of virtual objects;
ascertaining, from the stored object data and the item data, and automatically selecting which of the plurality of virtual objects optimizes improvements, the ascertaining and selecting being included as part of the optimization operation; and
applying a selected virtual object from the plurality of virtual objects to an exchange operation to transfer the one or more resources to the external location.

20. A computing system, comprising:
at least one processor;
a communication interface communicatively coupled to the at least one processor; and
a memory device storing executable code that, when executed, causes the processor to:
determine that an optimization operation for data base querying is being initiated;
receive item data associated with at least one item, the at least one item being obtainable by transferring one or more resources to an external location;
query one or more databases storing stored object data related to a plurality of virtual objects, the one or more resources being associated with one of the plurality of virtual objects; and
ascertain, from the stored object data and the item data, and select which of the plurality of virtual objects optimizes improvements, the ascertaining and selecting being included as part of the optimization operation.
